(19) United States
(12) Patent Application Publication
(10) Pub. No.: US 2024/0149643 A1
(43) Pub. Date: May 9, 2024

(54) REINFORCING BEAM FOR A VEHICLE

(71) Applicant: VALEO SYSTEMES THERMIQUES, La Verriere (FR)

(72) Inventors: Darshan PARIKH, Auburn Hills, MI (US); Sergio DA COSTA PITO, La Verriere (FR); Mark DAWSON, Auburn HIlls, MI (US); Thierry BARBIER, La Verriere (FR)

(73) Assignee: VALEO SYSTEMES THERMIQUES, La Verriere (FR)

(21) Appl. No.: 18/053,146

(22) Filed: Nov. 7, 2022

(51) Int. Cl. B60H 1/24; B62D 21/02

(52) U.S. Cl. CPC B60H 1/242; B62D 21/02

(57) ABSTRACT

The invention relates to a reinforcing beam for a vehicle, adapted to constitute at least a portion of a heating, ventilation and air conditioning assembly. It includes at least one air inlet, at least one air outlet and an air channel in-between. The reinforcing beam includes also a primary insert and a plastic body, the primary insert and the plastic body being connected with one another.

### TECHNICAL FIELD

The present invention relates to a reinforcing beam for a passenger compartment of a motor vehicle, intended to be installed transversely at the front of said passenger compartment and to support various equipment, in particular a heating/ventilation and/or air conditioning system or components thereof.

### BACKGROUND OF THE INVENTION

The front part of the passenger compartment of a motor vehicle, conventionally behind the engine compartment, is mainly occupied by a dashboard. The dashboard is generally supported by a rigid transverse beam firmly anchored on the right side and on the left side of the vehicle's body.

The same beam also supports, at least in part, other equipment in the passenger compartment, such as a heating/ventilation or air conditioning assembly (HVAC assembly), a column support for steering, or an airbag support.

The reinforcing beam is usually formed by a simple metal structure, which contributes to the rigidity of the self-supporting shell of the vehicle. However, a reinforcing beam of such kind represents a significant weight, and constitutes an obstacle to the routing of the air treated by the HVAC assembly.

Additionally, given current trends in the automotive industry, in particular relating to the shift from vehicles propelled by combustion engines to those utilizing electric motors, new requirements and challenges are emerging. One of those is the new concept of the passenger compartment, which promotes better use of space freed by elimination of combustion engine and related components, for example enabling more flexibility in terms of seats' position and design. Further, as sustainability becomes the main priority for the economy, reduction of amount of materials needed to manufacture a vehicle and the weight of these materials are key.

None of the above-mentioned factors removes the constant need for safety of the passengers. As the reinforcing beam is one of the structural elements, it remains crucial that it maintains, or even enhances, the safety level provided by the vehicle.

### BRIEF SUMMARY OF THE INVENTION

The object of the invention is, among others, a reinforcing beam for a vehicle, adapted to constitute at least a portion of a heating, ventilation and air conditioning assembly, with at least one air inlet, at least one air outlet and an air channel in-between, the reinforcing beam including a primary insert and a plastic body, the primary insert and the plastic body being connected with one another, wherein the primary insert is at least partially enclosed within the plastic body.

In one embodiment, the reinforcing beam includes at least one shell portion formed by both the primary insert and the plastic body.

In one embodiment, the reinforcing beam further includes a secondary insert made of metal.

In one embodiment, the at least one shell portion at least partially forms the air channel.

In one embodiment, the at least one shell portion forms an inner cavity in which at least one air conduit constituting at least portion of the air channel is inserted.

In one embodiment, the at least one air conduit is formed by both the primary insert and the plastic body.

In one embodiment, the at least one air conduit is formed exclusively by the plastic body.

In one embodiment, the plastic body and the primary insert include at least one pair of aligned rivet openings with a rivet placed therein to connect them.

In one embodiment, the primary insert is made of a composite material with glass.

In one embodiment, the primary insert is made of PA with 70% continuous glass fiber.

In one embodiment, the primary insert is made of PP with 70% continuous glass fiber.

In one embodiment, the primary insert is made of a composite material with carbon fibers.

Another object of the invention is a heating, ventilation and air conditioning assembly, comprising: a reinforcing beam for a vehicle, adapted to constitute at least a portion of a heating, ventilation and air conditioning assembly, with at least one air inlet, at least one air outlet and an air channel in-between, the reinforcing beam including a primary insert and a plastic body, the primary insert and the plastic body being connected with one another, wherein the primary insert is at least partially enclosed within the plastic body; and at least one heat exchanger communicated with the air channel.

In one embodiment, the heating, ventilation and air conditioning assembly further includes a housing in which the at least one heat exchanger is placed, the housing including a plastic casing being connected to the plastic body of the reinforcing beam.

In one embodiment, the plastic casing and the plastic body are one integral part.

In one embodiment, the housing includes a housing insert made of the same material as the primary insert of the reinforcing beam.

### BRIEF DESCRIPTION OF THE DRAWINGS

The present invention will be described in greater detail below with reference to the drawings. In the drawings:

FIG. 1 shows schematically an embodiment of an HVAC assembly according to the invention;

FIG. 2 shows schematically an embodiment of a reinforcement beam according to the invention;

FIG. 3 shows schematically another embodiment of a reinforcement beam according to the invention;

FIG. 4 shows schematically an exemplary structure of a component of the HVAC assembly of FIG. 1;

FIG. 5 shows schematically another exemplary structure of a component of the HVAC assembly of FIG. 1;

FIG. 6 is an exploded general view of the reinforcing beam according to another embodiment of the invention;

FIG. 7 is another exploded general view of the reinforcing beam according to embodiment of FIG. 6;

FIG. 8 is an exploded general view of the reinforcing beam according to another embodiment of the invention;

FIG. 9 is another general exploded view of the reinforcing beam according to the embodiment of FIG. 8;

FIG. 10 is an exploded general view of the reinforcing beam according to a variant of the embodiment of FIG. 6;

FIG. 11a illustrates another variant of the invention;

FIG. 11b illustrates yet another variant of the invention; and

FIG. 12 is a top general view of part of the reinforcing beam and an HVAC system according to the invention.

### DETAILED DESCRIPTION OF THE INVENTION

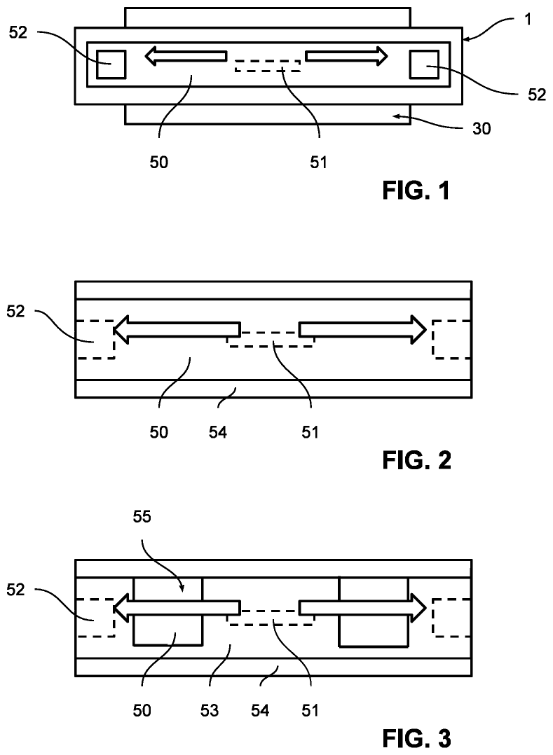

FIG. 1 shows schematically an embodiment of an HVAC assembly 30 according to the invention. The reinforcing beam 1 as shown is adapted to constitute at least a portion of a heating, ventilation and air conditioning assembly 30. The reinforcing beam 1 includes at least one air inlet 51, at least one air outlet 52, and an air channel in-between 50. The arrows indicate exemplary airflow paths.

FIG. 2 shows schematically an embodiment of a reinforcement beam 1 according to the invention. The reinforcement beam 1 includes at least one shell portion 54. The shell portion 54 gives an overall shape and structure to the reinforcing beam 1. Its function is also to ensure rigidity and serve for any mounting purposes, either of the reinforcing beam 1 to other vehicle components and structures or of the subcomponents of the reinforcing beam 1 itself. In the embodiment of FIG. 2, the shell portion 54 directly forms the air channel 50 between the air inlet 51 and the air outlets 52 through its adapted shape.

FIG. 3 shows schematically another embodiment of a reinforcement beam 1 according to the invention. The shell portion 54 forms an inner cavity 55 in which at least one air conduit 53 constituting a portion of the air channel 50 is inserted. In this example, the air conduit 53 does not occupy the whole inner cavity 55 and is partially open so that the shell portion 54 also contributes to guiding of the airflow. In other words, at least one shell portion 54 at least partially forms the air channel 50. The air conduit 53 can be in particular present in the areas of the air inlet 51 and the air outlets 52, allowing to precisely form those regions. The shell portion 54 can thus maintain a relatively uncomplicated shape.

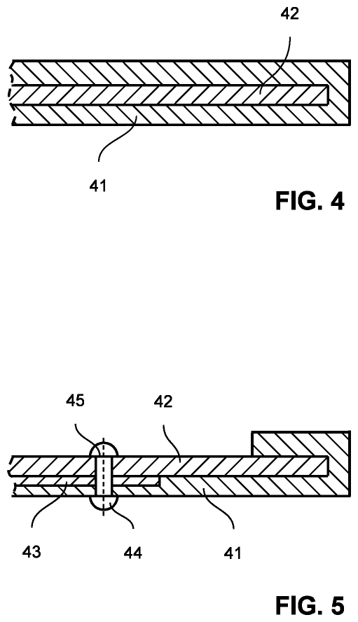

FIG. 4 shows schematically an exemplary structure of a component of the HVAC assembly 30, for example of the reinforcing beam 1. In general, the reinforcing beam 1 includes a primary insert 42 and a plastic body 41, the primary insert 42 and the plastic body 41 being connected with one another. In one example, the plastic body 41 is partially overmolded onto the primary insert 42. In other words, the primary insert 42 is at least partially enclosed within the plastic body 41. In another example, and as shown in FIG. 4, the primary insert 42 is completely enclosed within the plastic body 41. In other words, the plastic body 41 is overmolded onto entirety of the primary insert 42.

FIG. 5 shows schematically another exemplary structure of a component of the HVAC assembly 30, for example of the reinforcing beam 1. Here, the plastic body 41 and the primary insert 42 are connected to each other by rivets 44 placed in rivet holes 45, i.e. at least one pair thereof, made in the plastic body 41 and the primary insert 42. In addition, the plastic body 41 does not enclose the primary insert 42 completely. The reinforcing beam 1 can include a secondary insert 43 made of metal, such as for example aluminum or steel.

The structure shown in FIGS. 4 and 5 can be applied to any shell portion 54 of the reinforcing beam 1. In other words, at least one shell portion 54 is formed by both the primary insert 42 and the plastic body 41. This allows an option where at least one air conduit 53 is formed by both the primary insert 42 and the plastic body 41. In another embodiment, the at least one air conduit 53 is formed exclusively by the plastic body 41. In such case, the at least one shell portion 54 includes at least the primary insert 42, preferably also the plastic body 41.

The structure shown in FIGS. 4 and 5 can also be applied to any air conduit 53.

The plastic body 41 can be in form of an injected plastic structure.

In one example, the primary insert 42 is made of a composite material with glass.

In one example, the primary insert 42 is made of PA with 70% continuous glass fiber.

In one example, the primary insert 42 is made of PP with 70% continuous glass fiber.

In one example, the primary insert 42 is made of a composite material with carbon fibers.

Examples of materials that can be used for the primary insert 42 include, but are not limited to, thermoplastic resins as matrices with polypropylene (PP) and nylon (polyamide or PA); compression-moldable glass-mat thermoplastic (GMT) composites with chopped-fiber mats, in which GMT may be replaced by injection-molded pelletized long-fiber thermoplastics (LFT), PA, and PP; inline-compounded (ILC) injection- or compression-molded direct-LFT (D-LFT).

The plastic body 41 may have ribbing for enhancing rigidity or providing additional function, like connection points for further elements or air guiding.

As shown in the following figures, the general shape of the reinforcing beam 1 according to the invention can be that of a rectangular parallelepiped.

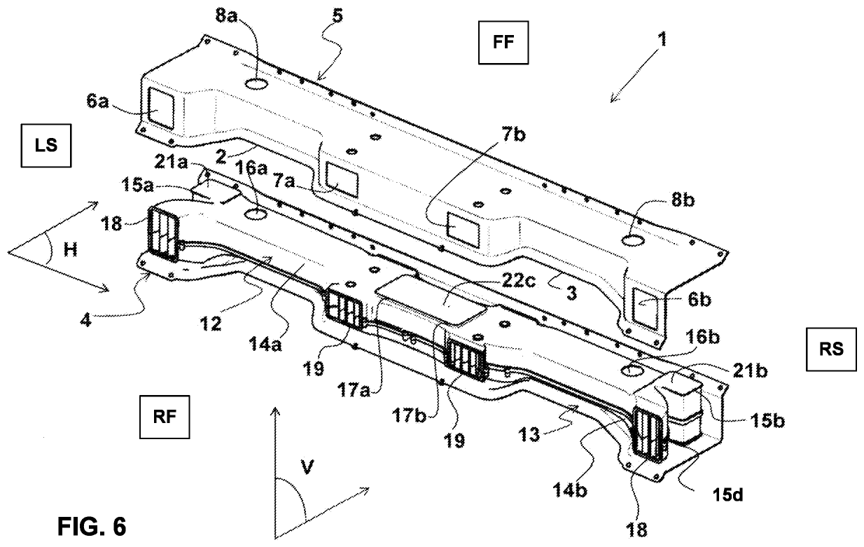

FIG. 6 is an exploded general view of the reinforcing beam 1 according to another embodiment of the invention. Intended to be installed transversely in the passenger compartment of a vehicle, the reinforcing beam 1 therefore has a front face FF (directed towards the front of the vehicle), a rear face RF (directed towards the rear of the vehicle), a left side LS and a right side RS.

The rear face RF of the reinforcing beam 1 comprises a left recess 2 and a right recess 3, symmetrical with respect to the vertical transverse plane V of the reinforcing beam 1 and adapted to receive for example a steering column support, an inflatable airbag or a glove compartment.

The reinforcing beam 1 includes a shell portion 54, in this case formed by a lower shell portion 4 and an upper shell portion 5, assembled longitudinally.

The lower shell portion 4 and the upper shell portion 5 have openings corresponding to the air inlet 51 and air outlets 52 of the previous figures, as will be explained in detail below.

FIGS. 6, 7, 8 and 9 show a left front outlet 6a, a right front outlet 6b, a left central outlet 7a and a right central outlet 7b arranged on the rear face RF of the upper shell portion 5. The same FIGURES also clearly show a left defrost outlet 8a and a right defrost outlet 8b on the upper face of the upper shell portion 5.

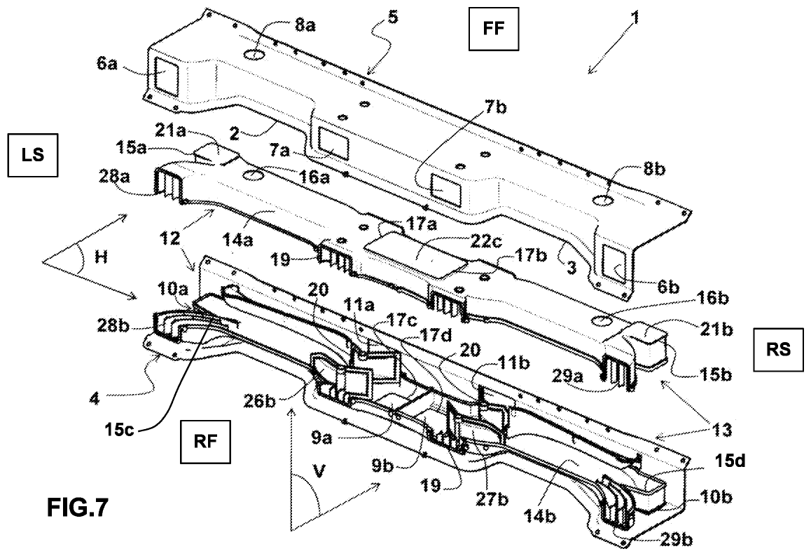

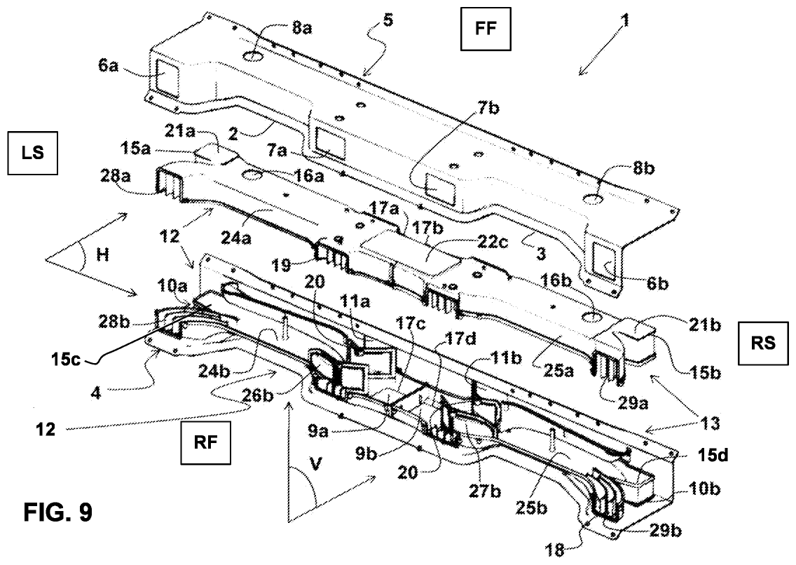

FIGS. 7 and 9, further show a left central air inlet 9a and a right central air inlet 9b within the bottom of the lower shell portion 4 constituting air inlets supplying the reinforcing beam 1.

The reinforcing beam 1 includes a lower left opening 10a and a right left opening 10b located in the bottom of the lower shell portion 4 intended for the rear ventilation and a left central defrost outlet 11a and a right central defrost outlet 11b in the front face FF intended for the central defrost.

Inside the cavity formed by the lower shell portion 4 and the upper shell portion 5 there is located the air conduit 53 in form of a left air conduit 12 and a right air conduit 13, placed symmetrically with respect to the vertical transverse plane V. In this case, the whole guiding of the air is carried out by the air conduit 53, while the shell portion 54 does not contribute substantially to controlling the path of the airflow.

In a first preferred embodiment of the invention, shown in FIGS. 6 and 7, both the left air conduit 12 and the right air conduit 13 are formed by an assembly of an upper air conduit portion 14a and a lower air conduit portion 14b extending in the longitudinal direction of the reinforcing beam 1.

The upper air conduit portion 14a and the lower air conduit portion 14b are symmetrical with respect to a horizontal plane H.

As clearly shown by means of the exploded views of the reinforcing beam 1, the outer profile of the assembled upper air conduit portion 14a and lower air conduit portion 14b substantially follows the inner profile of the lower half-shell 4 and the upper half shell 5, effectively shaping the air channel 50.

The parts with decreased cross section of the left air conduit 12 and the right air conduit 13 correspond to the left and right recesses 2, 3 of the lower and upper shell portions 4, 5, while the widest parts correspond to the front and central outlets 6a, 6b, 7a, 7b.

The upper air conduit portion 14a includes a left upper opening 15a, a right upper opening 15b, a left defrost opening 16a, a right defrost opening 16b, a left upper central opening 17a and a right upper central opening 17b. The lower air conduit portion 14b includes a left lower opening 15c, a right lower opening 15c, a left lower central opening 17c and a right lower central opening 17d.

The side walls of the upper air conduit portion 14a and the lower air conduit portion 14b include indentations which define outer air channel openings 18, inner air channel openings 19 and inside air channel openings 20 when assembled.

Due to the symmetry of the upper and lower air conduit portions 14a, 14b, the design and manufacture of each of them are simplified. In the shown embodiments, certain openings are not used. Left upper opening 15a, right upper opening 15b of the upper air conduit portion 14a are not used and are respectively closed by a left upper shutter 21a and a right upper shutter 21b. In any case, unused opening can be covered by shutters, which can be removable or irremovable.

In the embodiment shown in FIGS. 6 and 7, a left upper central opening 17a and a right upper central opening 17b are arranged symmetrically with respect to a left lower central opening 17c and a right lower central opening 17d. The left lower central opening 17c and the right lower central opening 17d correspond respectively to the left central inlet 9a and the right central inlet 9b. The left upper central opening 17a and the right upper central opening 17b are in this case not used and closed by an upper central shutter 22c.

A left lower opening 15c and a right lower opening 15d, intended for rear ventilation, correspond respectively to a left rear opening 10a and a right rear opening 10b.

The left defrost opening 16a and the right defrost opening 16b of the upper air conduit portion 14a face respectively a left defrost outlet 8a and a right defrost outlet 8b intended for lateral defrosting.

Similarly, FIG. 7 shows an integration of left and right distribution flaps 26b, 27b, left upper guide flap 28a, left lower guide flap 28b, right upper guide flap 29a, right lower guide flap 29b.

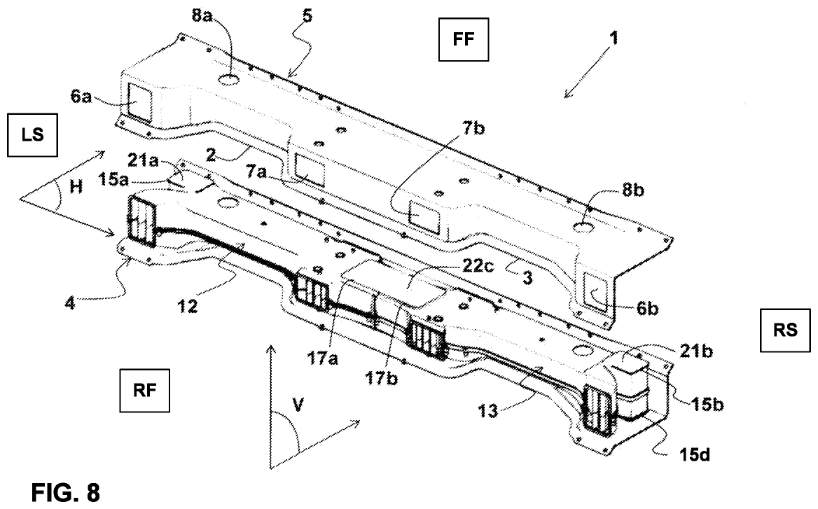

In another embodiment of the invention, shown in FIGS. 8 and 9, the air conduit 53 is formed by separated left air conduit 12 and right air conduit 13 placed in the lower shell portion 4 and the upper shell portion 5 of the reinforcing beam 1. The left air conduit 12 and the right conduit 13 are of identical general shape, mirrored by median transversal plane V.

As shown in FIGS. 8 and 9, the concealment of the left and right upper center openings 17a, 17b can be advantageously carried out by means a common central shutter 22c.

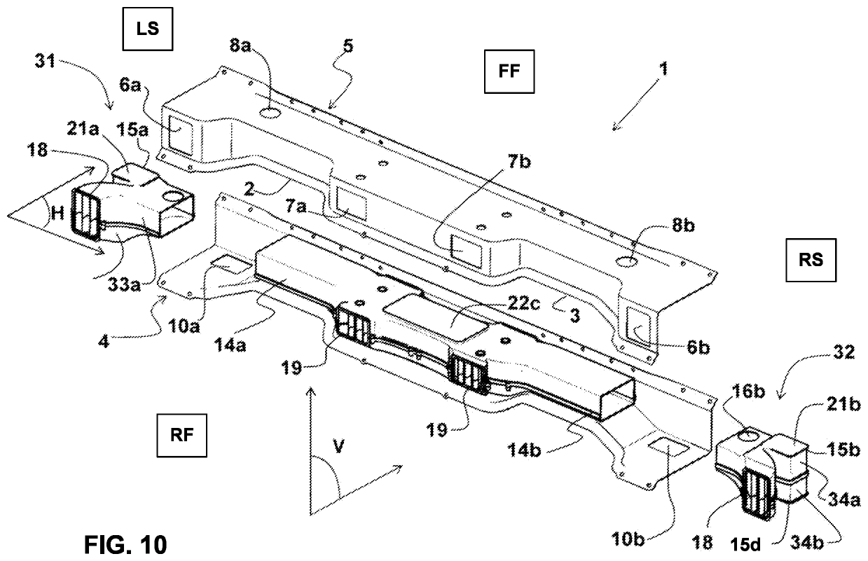

According to another embodiment, as shown in FIG. 10, the assembly includes left and right endpieces 31, 32 at its ends.

Just as the left and right air conduits 12, 13 arranged on the left and right of the vertical transverse plane V as described before each consist of left upper shell portion 24a, left lower shell portion 24b, right upper shell portion 25a, right lower shell portion 25b, the end pieces 31, 32 are each formed of left lower half-endpiece 33a, left upper half-endpiece 33b, right lower half-endpiece 34a, left upper half-endpiece 34b assembled along the horizontal plane H.

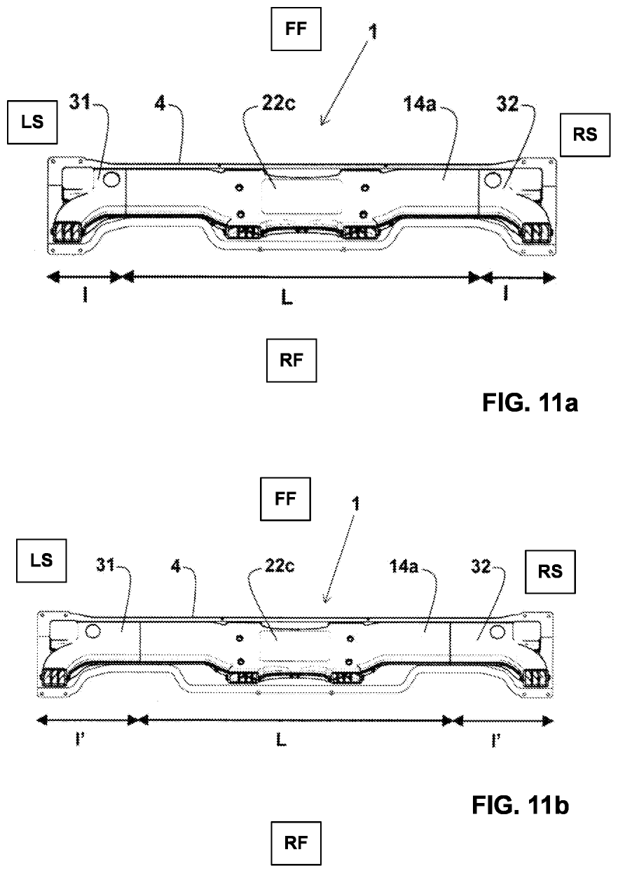

As clearly shown in FIGS. 11a and 11b, the length L of the upper and lower air conduit portions 14a, 14b can be fixed for all vehicles in the same range, while the length I, the right and left endpieces 31, 32 can be adapted to the width of the passenger compartment for which the reinforcing beam 1 is intended.

The central part of the air conduit 53 as shown is generally a relatively complex piece because it contains the distribution and guide flaps, while the ends are less complicated. The adoption of modular ends makes it possible to provide end elements that are simple to manufacture, while the most technical central part remains identical for all vehicles in the same range, thus enabling cost savings.

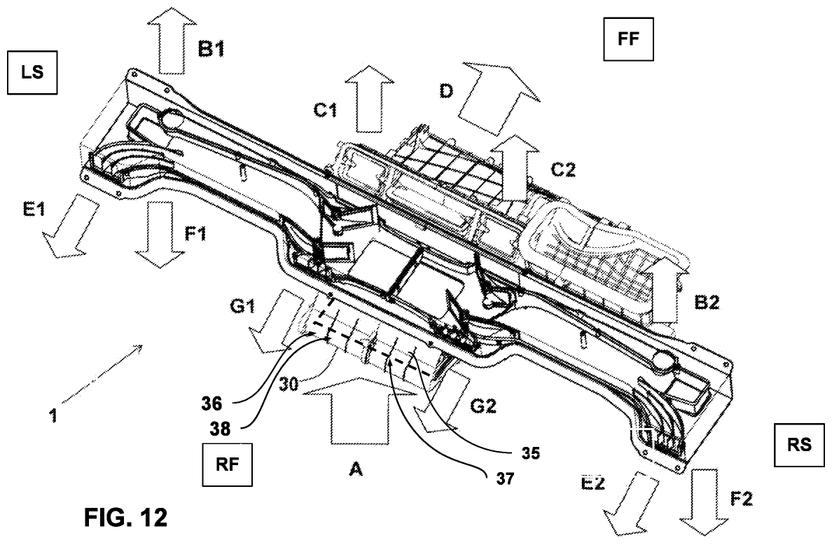

FIG. 12 presents the reinforcing beam 1 according to the invention applied within a heating/ventilation/air conditioning system 30. The HVAC assembly 30 manages airflow so that at least the following are created:
incoming airflow A through the left and right central air openings 9a, 9b;
left and right defrost airflows B1, B2 through left and right defrost outlets 8a, 8b;
left and right central defrost airflows C1, C2 through left and right central defrost outlets 11a, 11b;
soft diffusion airflow D through left and right central defrost outlets 11a, 11b;
left and right front ventilation airflows E1, E2 through left and right front outlets 6a, 6b;
left and right rear ventilation airflows F1, F2 through left and right rear openings 10a, 10b;
left and right central front ventilation airflows G1, G2 through outer air channel openings 19.

The HVAC assembly 30 includes at least one heat exchanger 35 communicated with the air channel 50. The heat exchanger 35 can for example be an evaporator. Preferably, there is a plurality of heat exchangers 35—in addition to the evaporator, there can also be a heater core, a PTC heater, an inner condenser. Any heat exchanger 35 can be located within a housing 36 including a plastic casing 37 being connected to the plastic body of the reinforcing beam 1. Preferably, the plastic casing 37 and the plastic body 41 of the reinforcing beam 1 are one integral part.

The housing 36 can include a housing insert 38 made of the same material as the primary insert 42 of the reinforcing beam 1. In some variants, the housing insert 38 and the primary insert 42 can one integral part.

In any case, the structure variants of FIGS. 4 and 5 can be applied to the housing 36, in particular the plastic casing 37 corresponding to the plastic body 41 and the housing insert 38 corresponding to the primary insert 42.

Other variations to the disclosed embodiments can be understood and effected by those skilled in the art in practicing the claimed invention, from a study of drawings, the disclosure, and the appended claims. The mere fact that certain measures are recited in mutually different dependent claims does not indicate that a combination of these measures cannot be used to the advantage.

What is claimed is:

1. A reinforcing beam for a vehicle, adapted to constitute at least a portion of a heating, ventilation and air conditioning assembly, with
at least one air inlet, at least one air outlet and an air channel in-between,
the reinforcing beam including a primary insert and a plastic body, the primary insert and the plastic body being connected with one another, wherein the primary insert is at least partially enclosed within the plastic body.

2. The reinforcing beam according to claim 1, including at least one shell portion formed by both the primary insert and the plastic body.

3. The reinforcing beam according to claim 1, further including a secondary insert made of metal.

4. The reinforcing beam according to claim 2, wherein the at least one shell portion at least partially forms the air channel.

5. The reinforcing beam according to claim 2, wherein the at least one shell portion forms an inner cavity in which at least one air conduit constituting at least portion of the air channel is inserted.

6. The reinforcing beam according to claim 5, wherein the at least one air conduit is formed by both the primary insert and the plastic body.

7. The reinforcing beam according to claim 5, wherein the at least one air conduit is formed exclusively by the plastic body.

8. The reinforcing beam according to claim 1, wherein the plastic body and the primary insert include at least one pair of aligned rivet openings with a rivet placed therein to connect them.

9. The reinforcing beam according to claim 1, wherein the primary insert is made of a composite material with glass.

10. The reinforcing beam according to claim 9, wherein the primary insert is made of PA with 70% continuous glass fiber.

11. The reinforcing beam according to claim 9, wherein the primary insert is made of PP with 70% continuous glass fiber.

12. The reinforcing beam according to claim 1, wherein the primary insert is made of a composite material with carbon fibers.

13. A heating, ventilation and air conditioning assembly, comprising:
a reinforcing beam for a vehicle, adapted to constitute at least a portion of a heating, ventilation and air conditioning assembly, with
at least one air inlet, at least one air outlet and an air channel in-between,
the reinforcing beam including a primary insert and a plastic body, the primary insert and the plastic body being connected with one another, wherein the primary insert is at least partially enclosed within the plastic body; and
at least one heat exchanger communicated with the air channel.

14. The heating, ventilation and air conditioning assembly according to claim 13, further comprising a housing in which the at least one heat exchanger is placed, the housing including a plastic casing being connected to the plastic body of the reinforcing beam.

15. The heating, ventilation and air conditioning assembly according to claim 14, wherein the plastic casing and the plastic body are one integral part.

16. The heating, ventilation and air conditioning assembly according to claim 14, wherein the housing includes a housing insert made of the same material as the primary insert of the reinforcing beam.
